(19) United States
(12) Patent Application Publication
(10) Pub. No.: US 2017/0316094 A1
(43) Pub. Date: Nov. 2, 2017

(54) BROWSER BASED, PLUGGABLE, WORKFLOW DRIVEN BIG DATA PIPELINES AND ANALYTICS SYSTEM

(71) Applicant: Sparkflows, Inc., Milpitas, CA (US)

(72) Inventor: Jayant Shekhar, Milpitas, CA (US)

(73) Assignee: Sparkflows, Inc., Milpitas, CA (US)

(21) Appl. No.: 15/583,836

(22) Filed: May 1, 2017

Related U.S. Application Data
(60) Provisional application No. 62/329,931, filed on Apr. 29, 2016.

(51) Int. Cl. G06F 17/30

(52) U.S. Cl. CPC G06F 17/30864; G06F 17/30905; G06F 17/30941

(57) ABSTRACT

A system of the present invention enables the running of browser based, pluggable Big Data Applications powered by intelligent workflows. The system receives from a user computer browser application a request for execution of a workflow. The request is submitted for execution of the workflow to the Spark® cluster as a Spark® job including information about the workflow details. The result of the execution of the workflow is received from the driver running on the Spark® cluster after each node of the workflow request has been executed on the Spark® cluster. A JSON/XML-format files containing the received results of the execution of the workflow is then created, such that when the JSON/XML format files are processed by the user computer web browser, the results are displayed on the user computer as rich text/table/chart/tree visual displays.

### RELATED APPLICATION DATA

This application claims priority to U.S. provisional patent application 62/329,931, filed on Apr. 29, 2016, which is incorporated by reference along with all other references cited in this application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to big data processing.

### BACKGROUND OF THE INVENTION

Hadoop® is being increasingly used for processing of big data. Hadoop® scales extremely well for storing and processing of very large data sets. The data on Hadoop® is got from various sources including databases, logs from machines, sensor data, and the like.

On Hadoop®, Apache™ Spark® is being increasingly used for processing of the data. The various kinds of processing include reporting jobs, predictive modeling, graph processing, and the like. It also is used to find patterns in the incoming data.

Big Data systems like Hadoop® and Spark® are intrinsically messy to handle and minimal development takes a lot of time to get started especially because of the existence of huge number of configuration files and getting to know the system architecture. Most of the coding effort, lies in the step of getting to know the application program interfaces (API) being exposed, optimizing it to work at maximum efficiency, and connecting the pipelines.

The current big data applications and pipelines are being built by hand-coding the processing of the data. This result is very long development times and it results in lots of maintenance difficulties. It is also very difficult to take these systems to production with all the complexities and dependencies built in. Building higher level applications is even more difficult without intelligent visualization which causes the business, data scientists and data engineers to have a hard time working together.

It would be desirable to have a workflow driven user interface to build such a pipeline. It would not only significantly simplify the big data application development process, but also allows more kinds of users to use the system like business users, data analysts and big data engineers.

Applications like Talend and Cask, currently provide graphical ways to build the data pipelines on Apache™ Spark®. But these current application systems are significantly different from what is being described below. Talend runs in Eclipse and is developer friendly. However, the business users and the data scientists cannot holistically use the system.

### SUMMARY

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Many Big Data Applications are being built. Big Data Applications and Pipelines are customarily integrated within various Big Data Systems. Described below is a system that enables running browser based, pluggable Big Data Applications powered by intelligent workflows. The system has a Spark® Engine that runs various nodes connected to each other in a directed acyclic graph (DAG). The nodes have the ability to pass DataFrame and Models to its next connected nodes.

This system allows building and sharing workflows. It also allows building higher level big data applications like Recommendations, Churn Analytics, Customer 360 internet of things (IoT), Customer Analytics and the like.

### BRIEF DESCRIPTION OF THE FIGURES

FIG. 1 is an overall system diagram according to an embodiment of the invention.

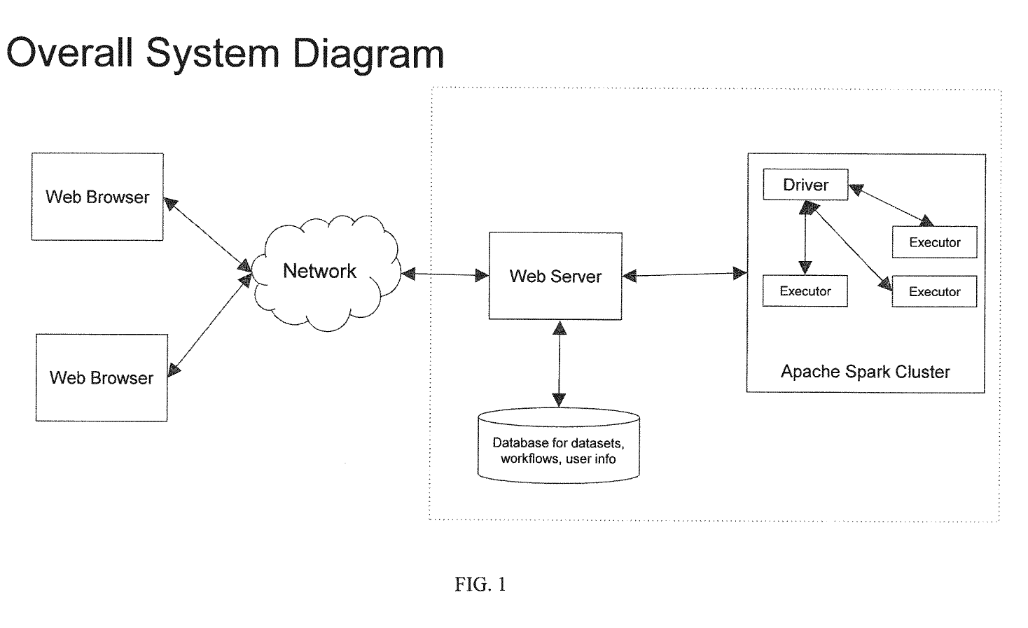

FIG. 2 is a block diagram and user interface for the Workflow User Interface according to an embodiment of the invention.

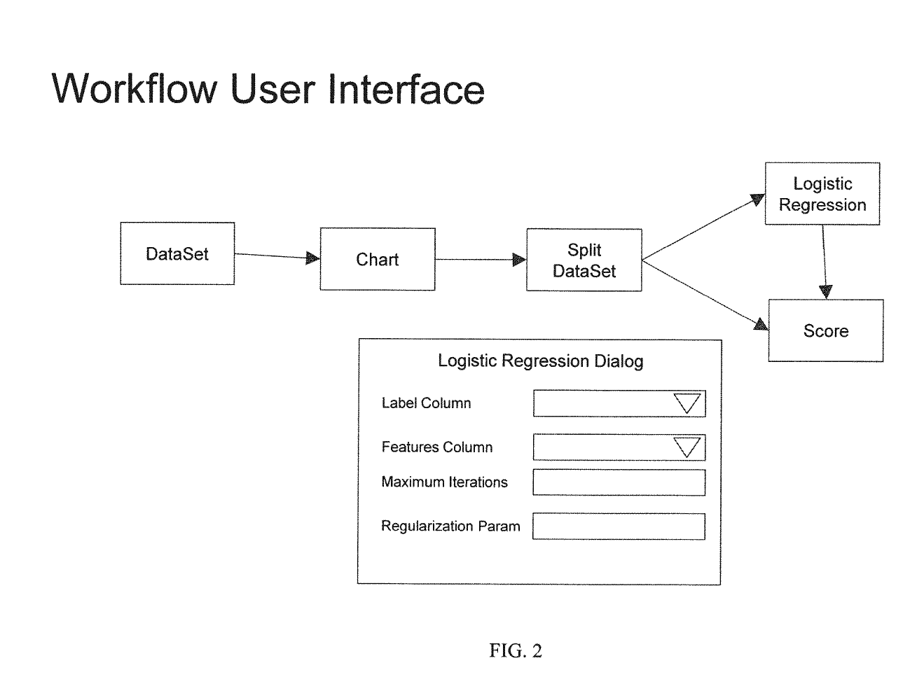

FIG. 3 is a flow chart of workflow execution according to an embodiment of the invention.

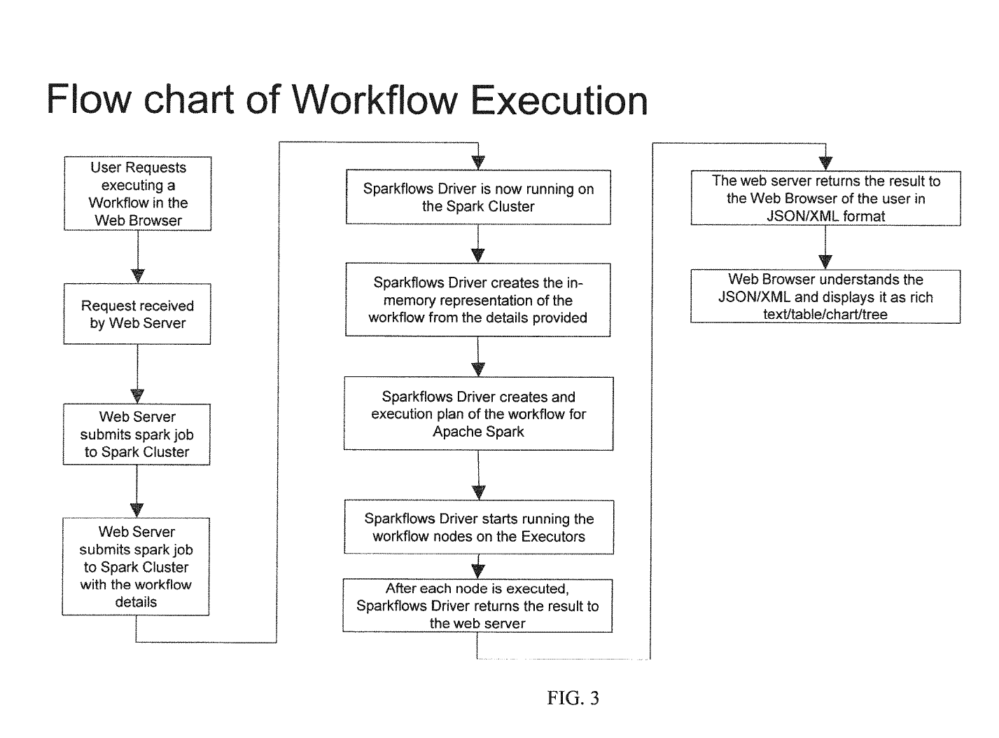

FIG. 4 is a flow chart of adding a new node into the system according to an embodiment of the invention.

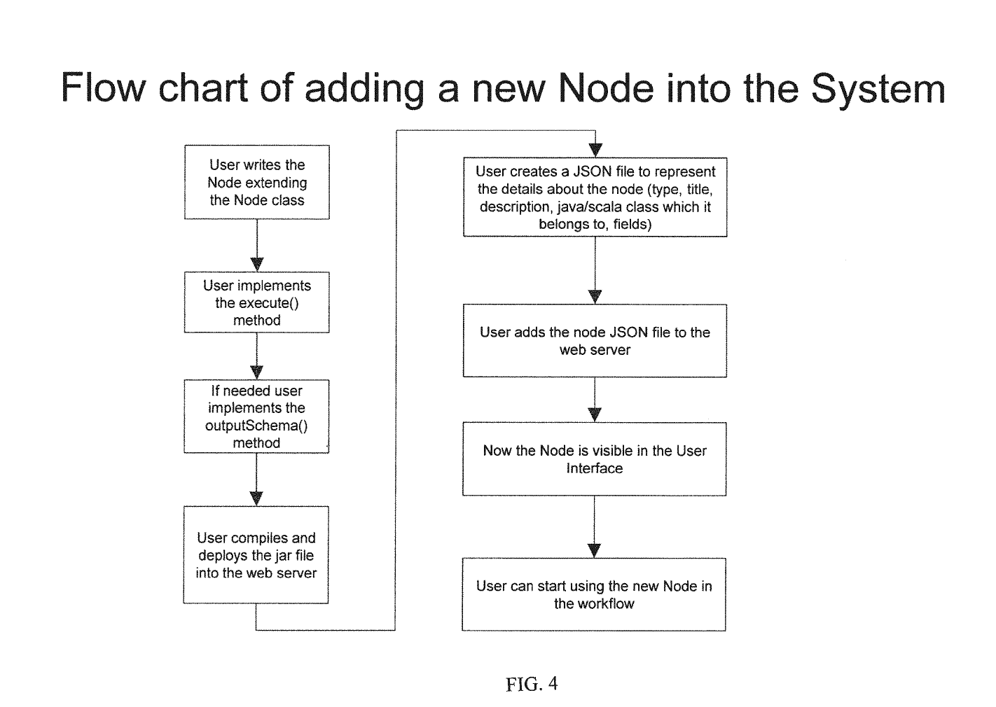

FIG. 5 is a flow chart of displaying rich content in the user interface according to an embodiment of the invention.

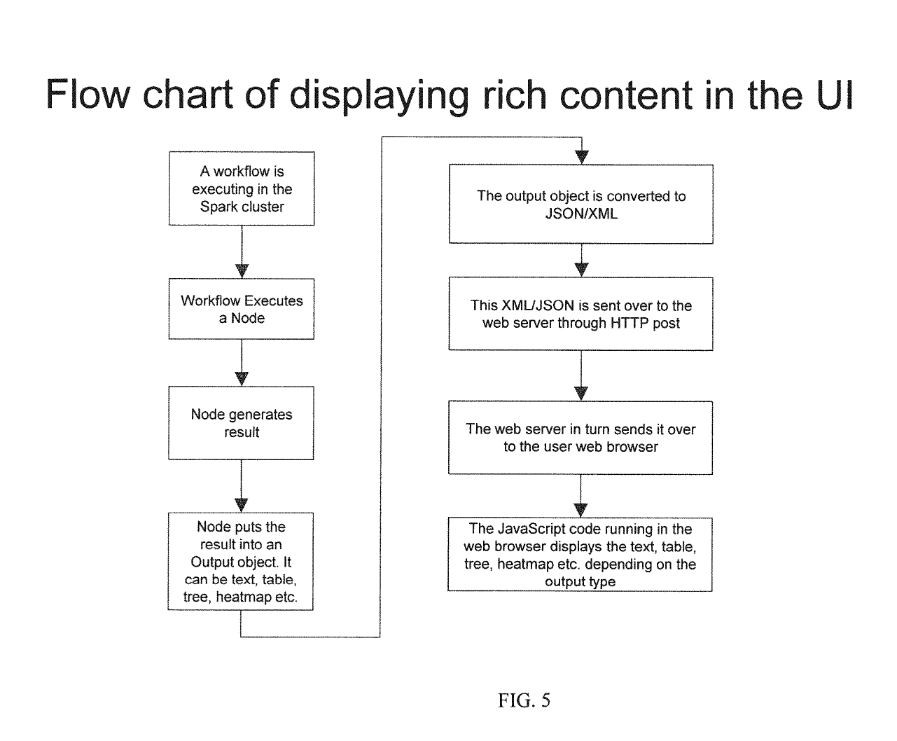

FIG. 6 is a flow chart of adding a new output type to be displayed in the web browser according to an embodiment of the invention.

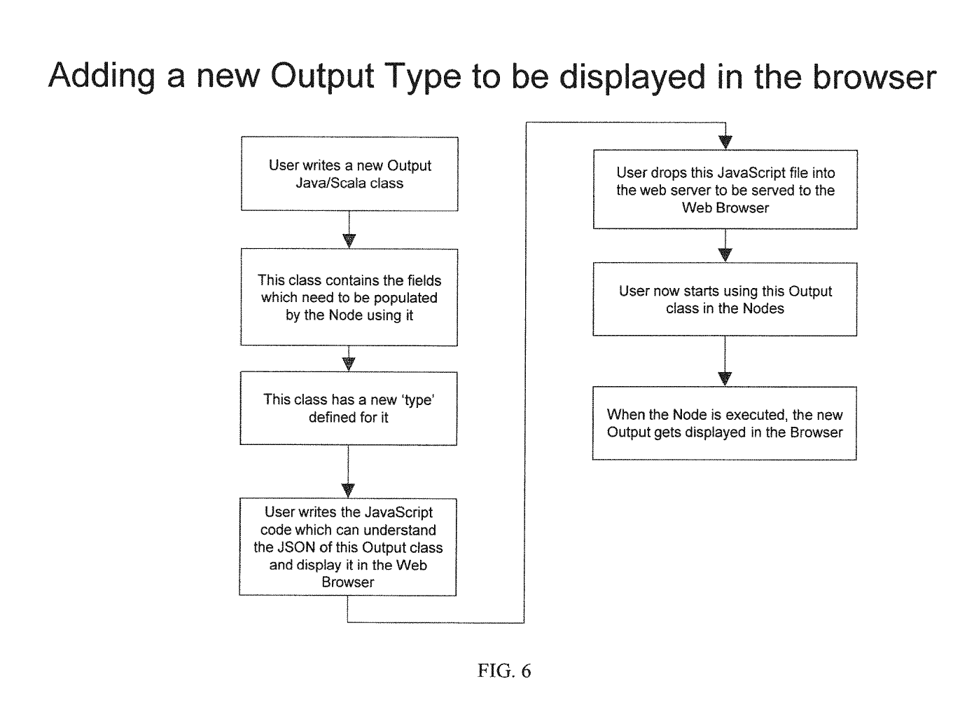

FIG. 7 is a flow chart for schema propagation according to an embodiment of the invention.

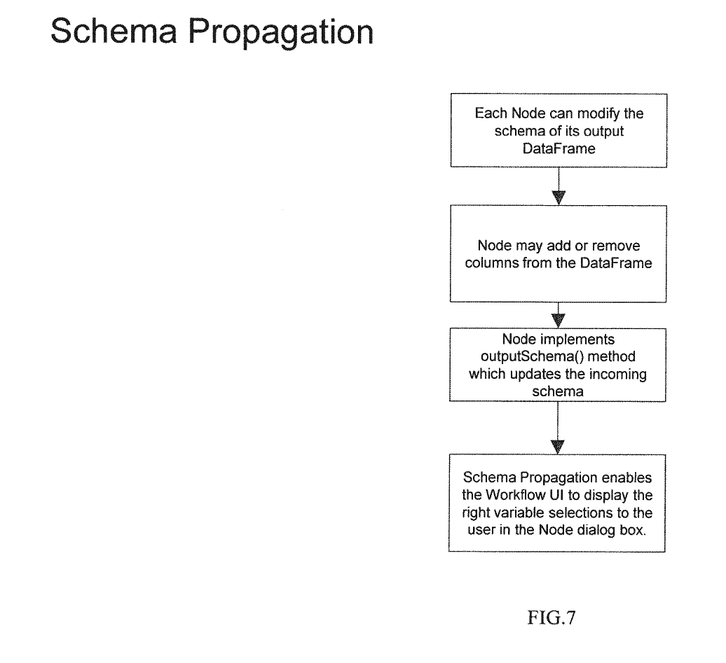

FIG. 8 is a work flow user interface screenshot according to an embodiment of the invention.

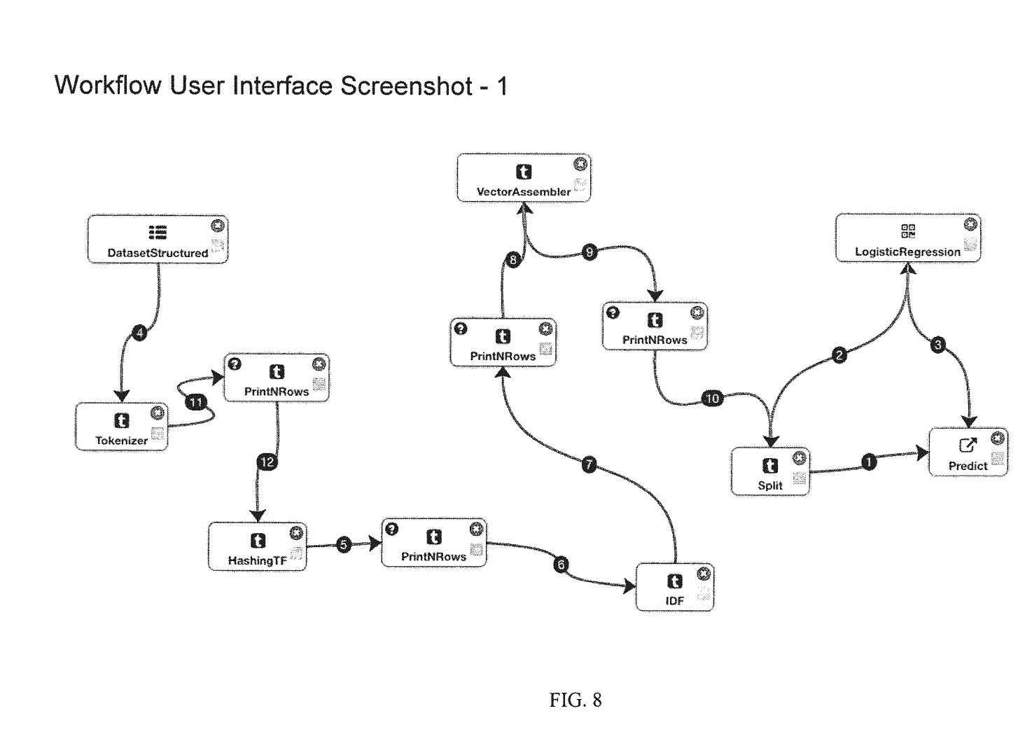

FIG. 9 is a work flow user interface screenshot according to an embodiment of the invention.

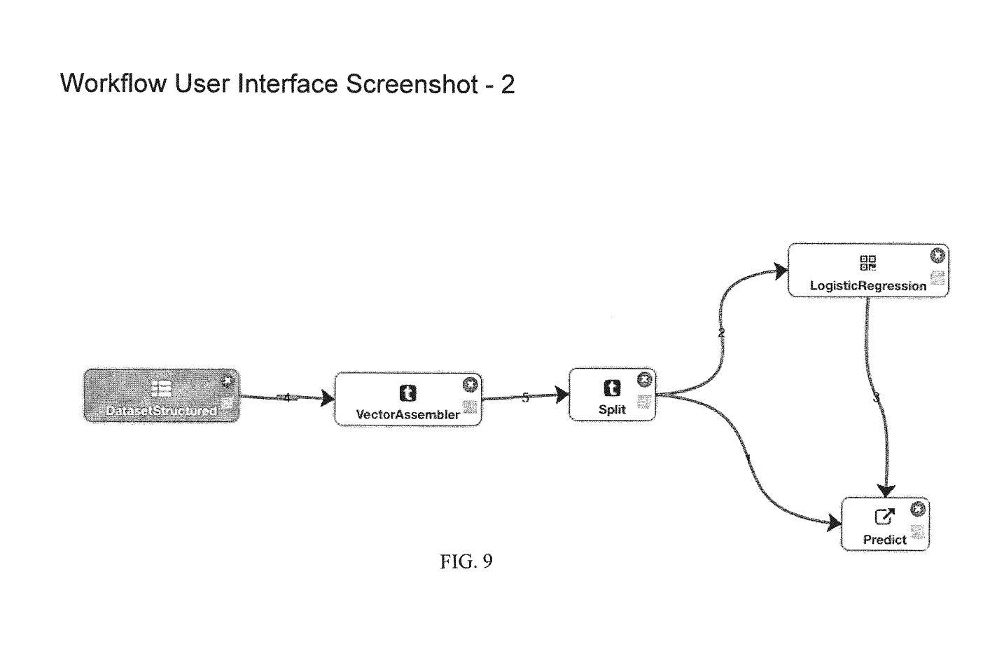

FIG. 10 is a first workflow dialog box screenshot according to an embodiment of the invention.

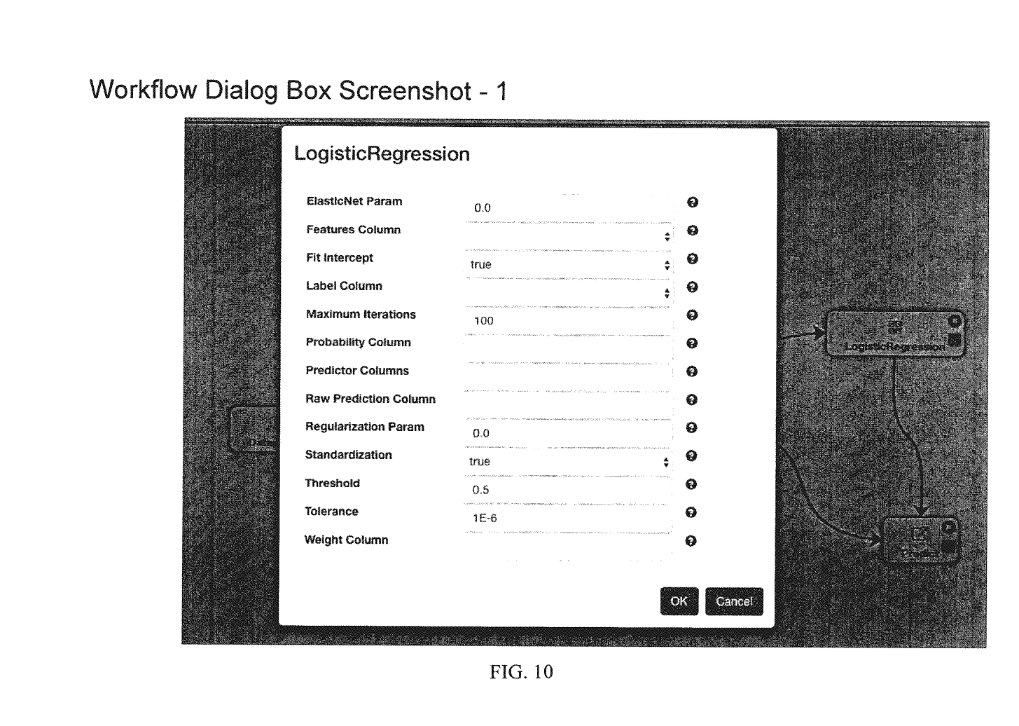

FIG. 11 is a second workflow dialog box screenshot according to an embodiment of the invention.

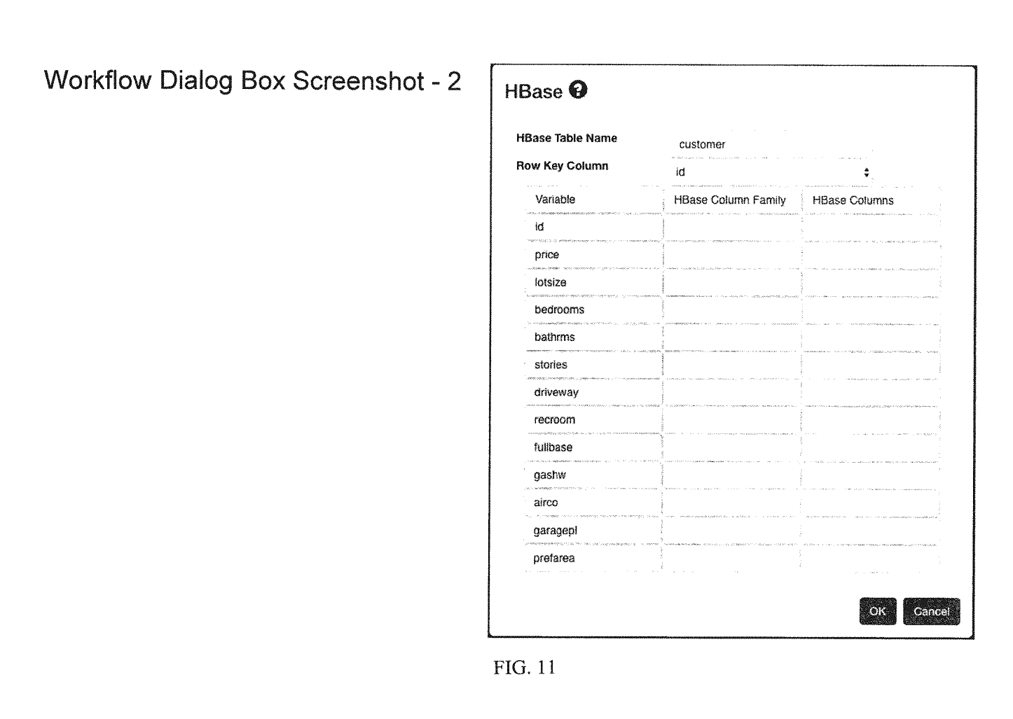

FIG. 12 is a list of nodes screenshot according to an embodiment of the invention.

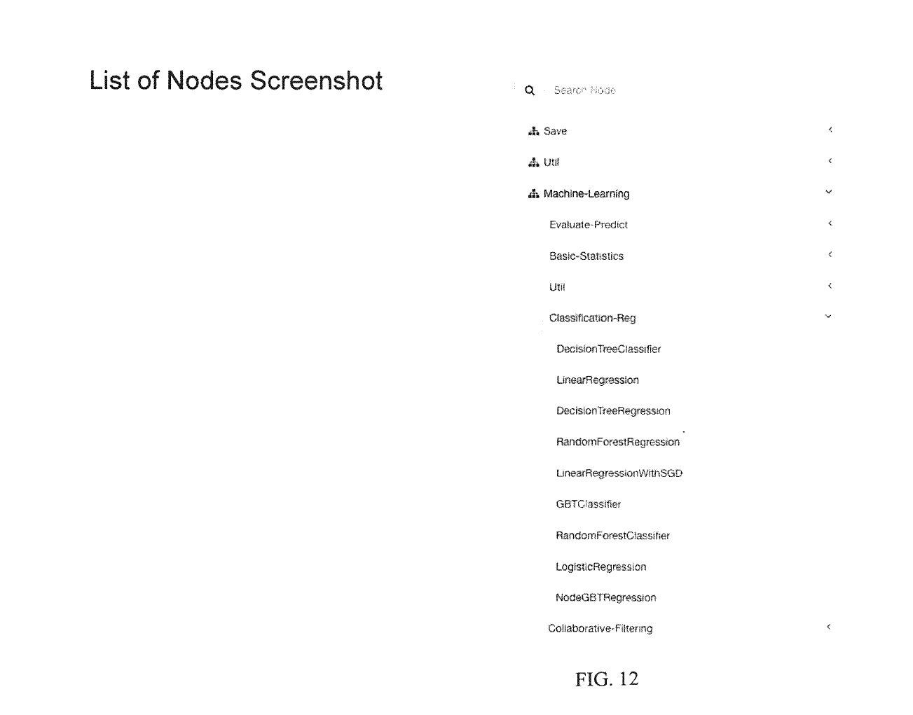

FIG. 13 is a list of datasets screenshot according to an embodiment of the invention.

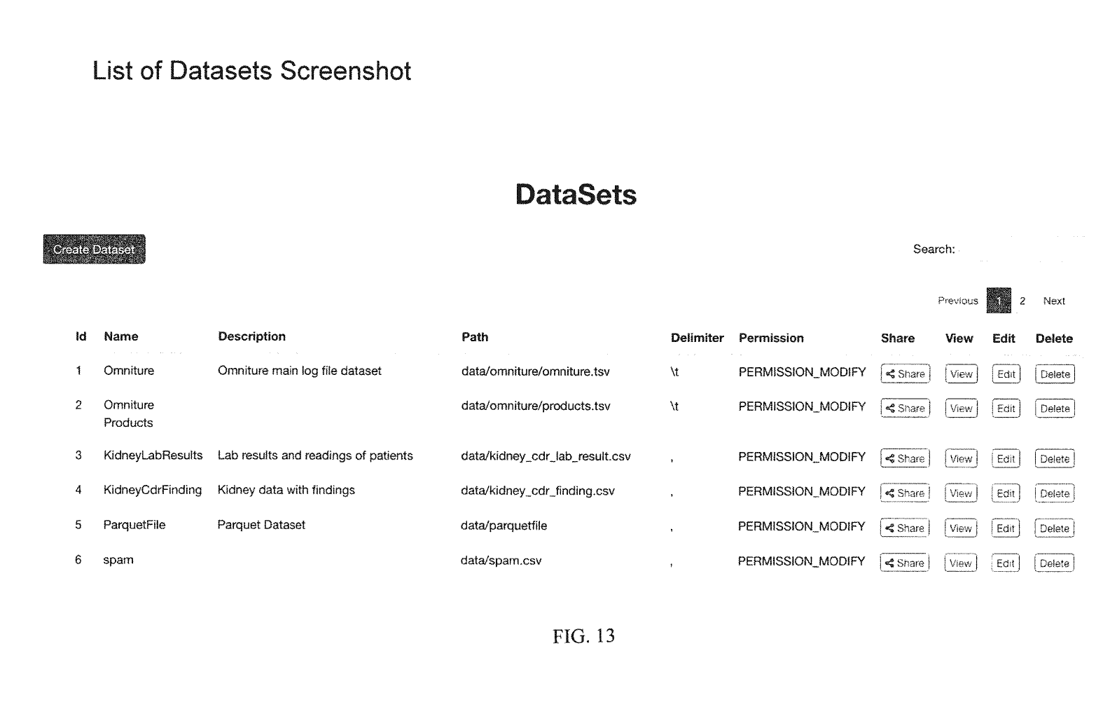

FIG. 14 is a dataset definition screenshot according to an embodiment of the invention.

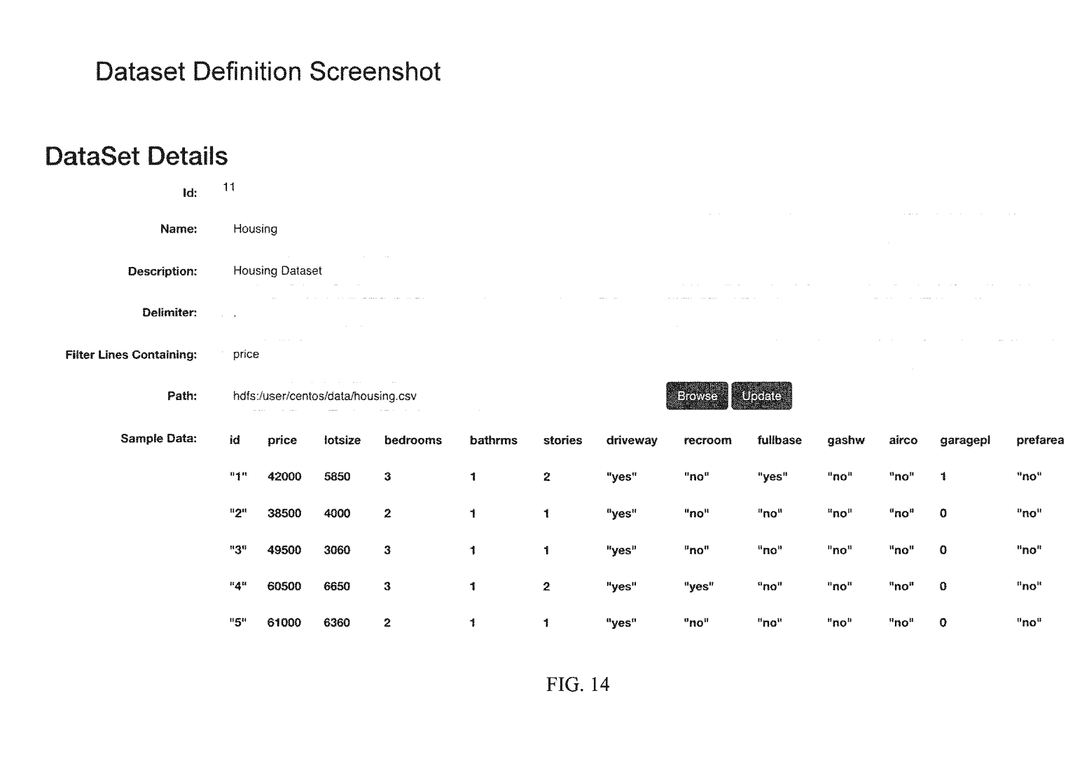

FIG. 15 is a dataset schema definition screenshot according to an embodiment of the invention.

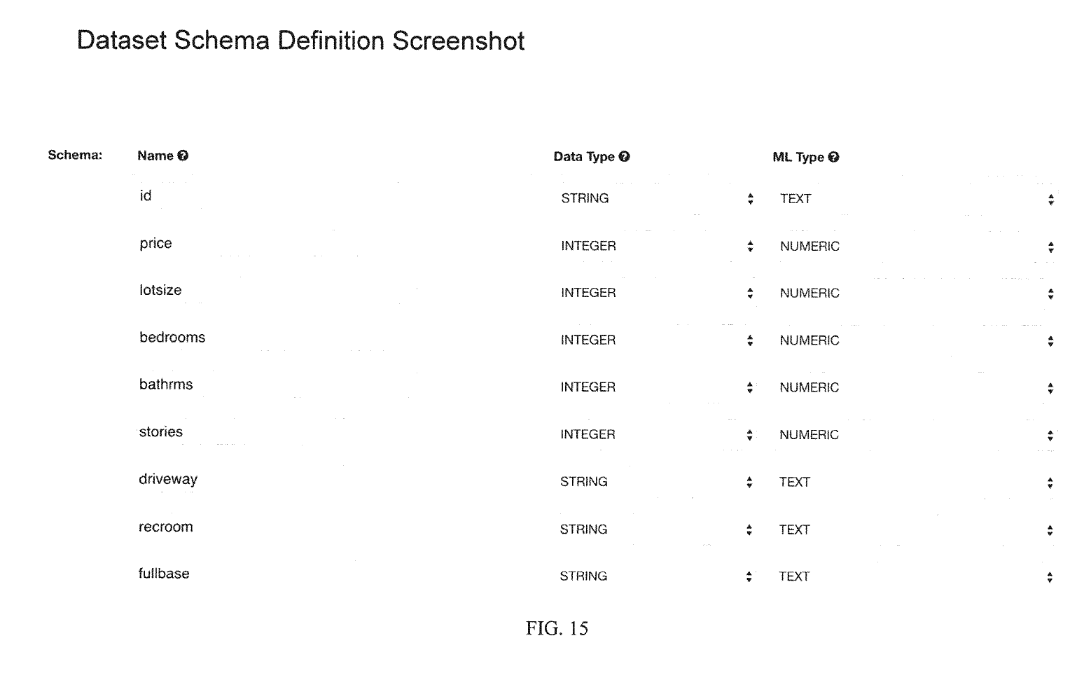

FIG. 16 is a first workflow execution screenshot according to an embodiment of the invention.

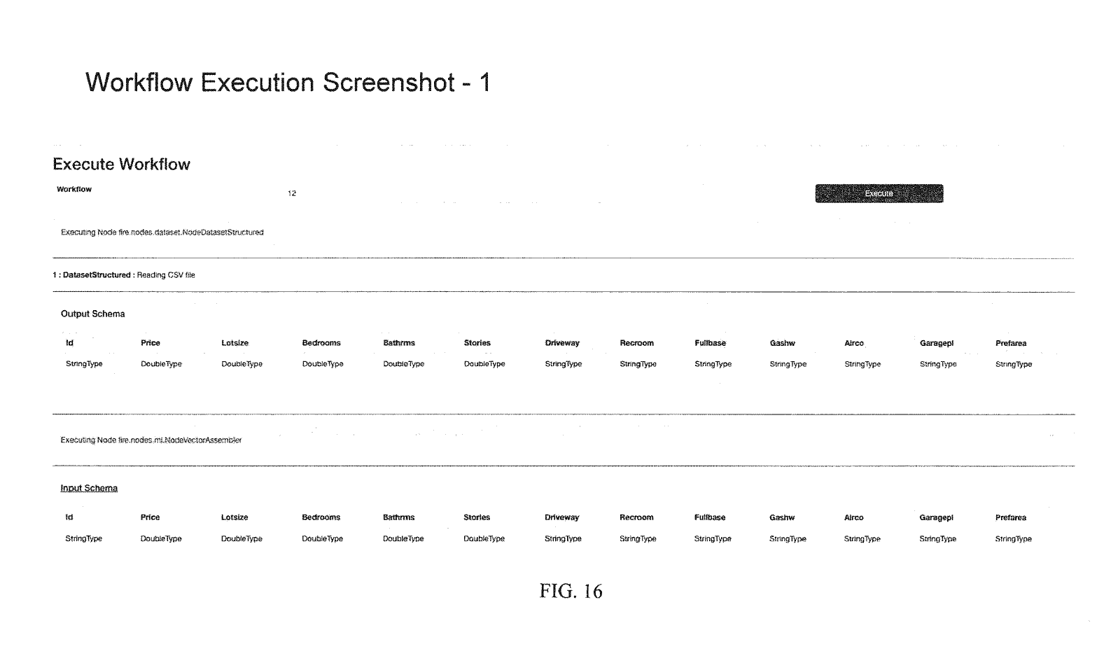

FIG. 17 is a second workflow execution screenshot according to an embodiment of the invention.

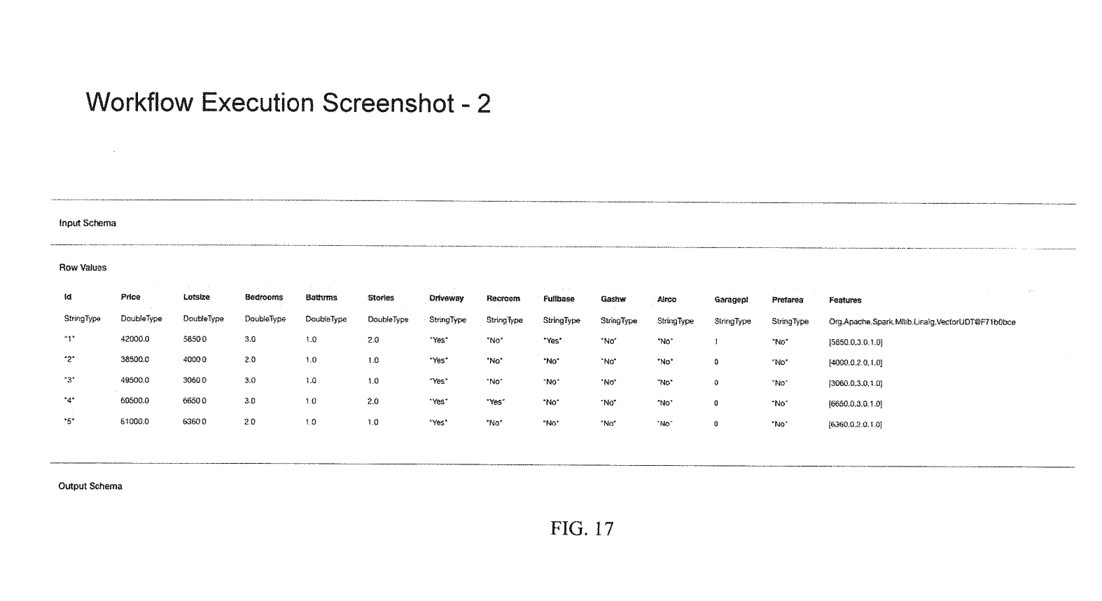

FIG. 18 is a third workflow execution screenshot according to an embodiment of the invention.

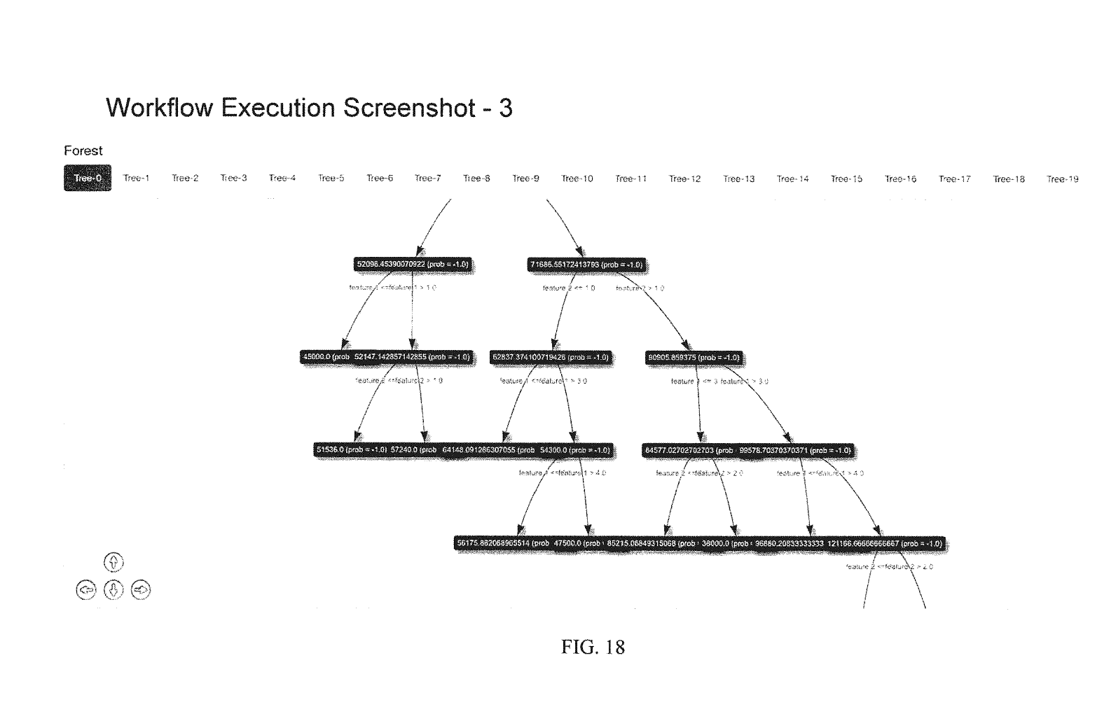

FIG. 19 is a fourth workflow execution screenshot according to an embodiment of the invention.

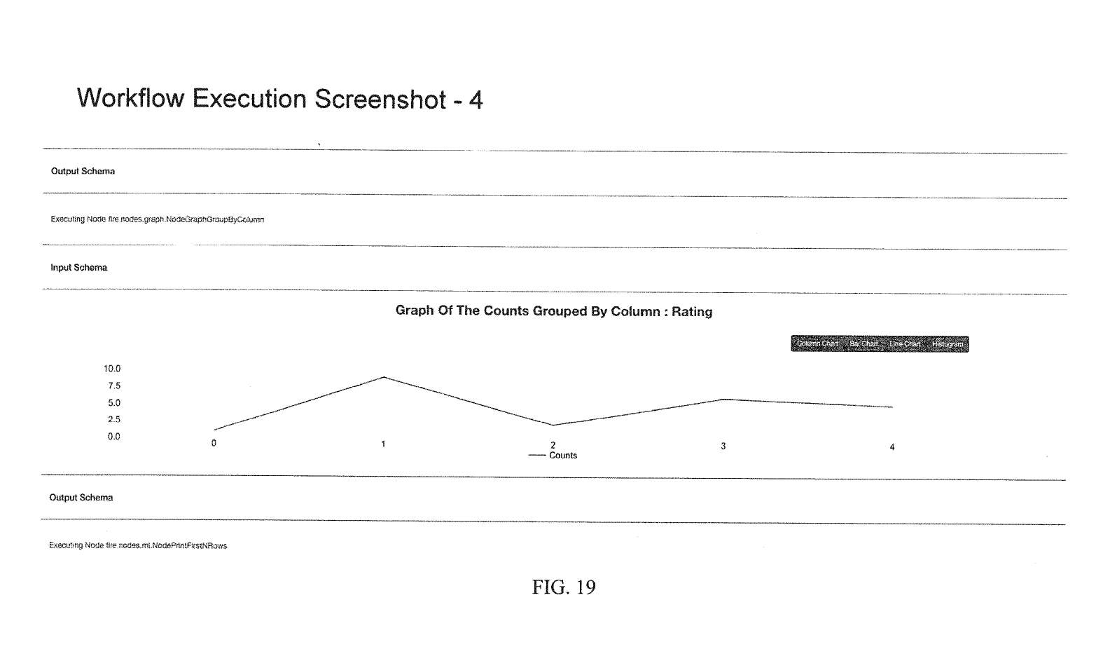

FIG. 20 is a fifth workflow execution screenshot according to an embodiment of the invention.

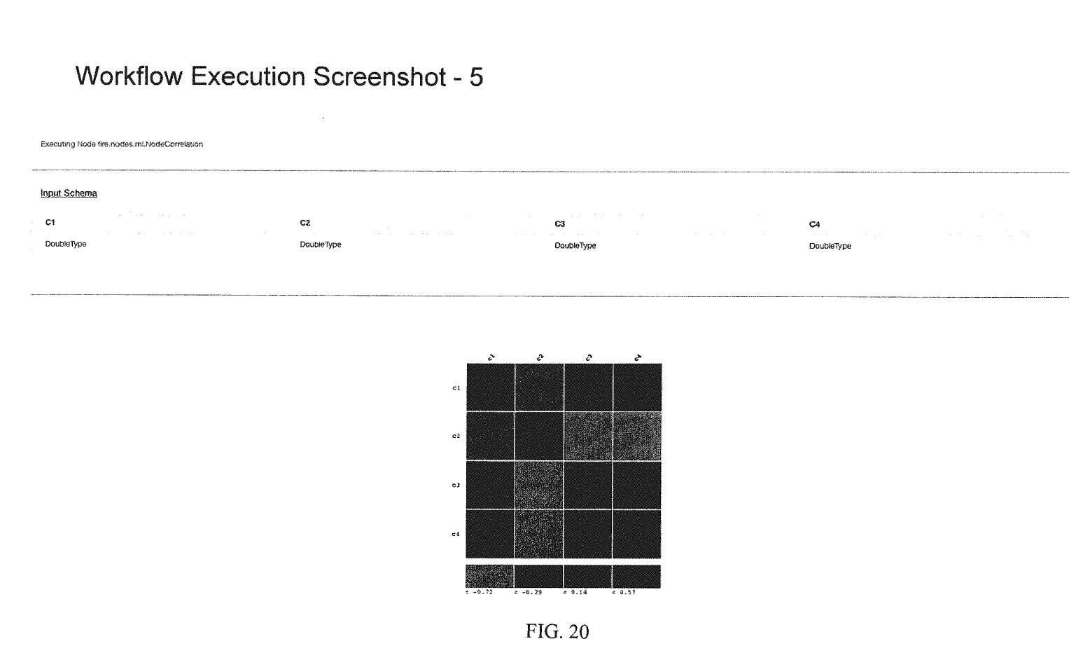

FIG. 21 is a viewing past executions screenshot according to an embodiment of the invention.

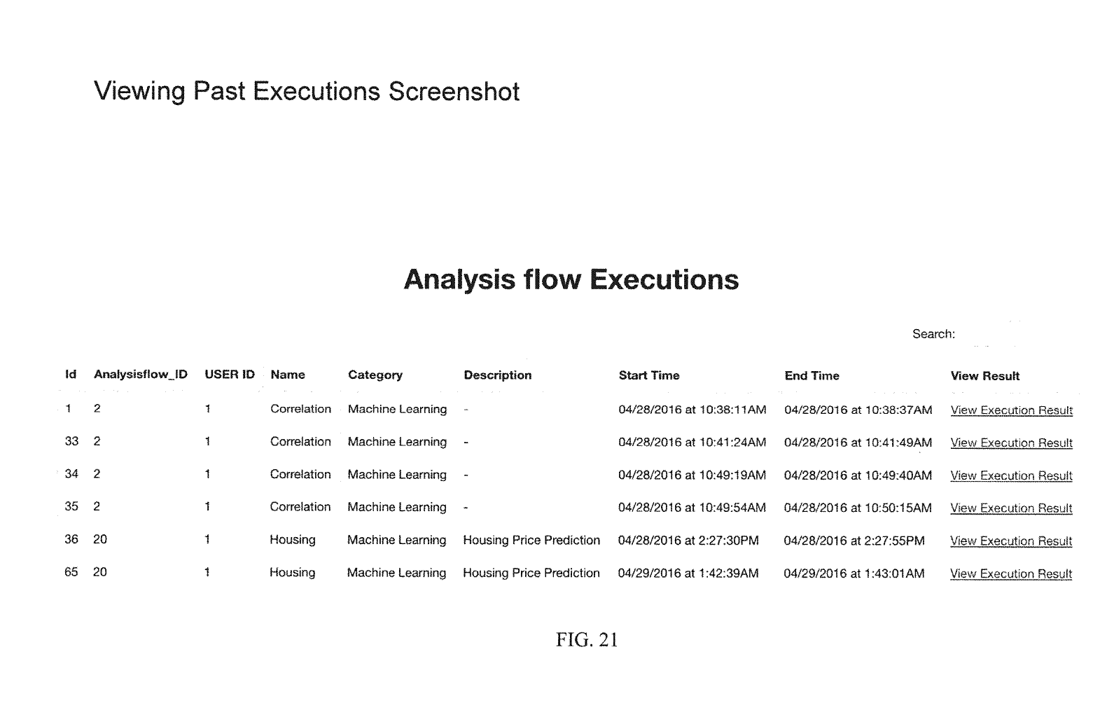

### DETAILED DESCRIPTION OF THE INVENTION

This is a system that enables running browser based, pluggable Big Data Applications powered by intelligent workflows. It has a Spark® Engine that runs various Nodes connected to each other in a DAG. The nodes have the ability to pass DataFrame and Models to its next connected nodes.

The user interacts with the system through their web browser. The system allows the user to define datasets, build and execute workflows. The system also allows the user to schedule the workflow to be run on Apache™ Spark® through their favorite scheduler including Oozie, Crontab, etc.

When the user executes the workflow, it is run on Apache™ Spark® and the results of execution of each of the nodes are streamed back to the user's web browser and displayed in rich format. Each of the results can be in text, graph, trees, heatmap, etc. The user can extend the system to add their own ways to display the output in the web browser by adding their own JavaScript to the system.

When a job is submitted to Apache™ Spark®, it has a driver component which controls the overall execution of the job, and executors which are run in a distributed manner on multiple nodes on the Spark® Cluster. So, in this embodiment the workflow job is submitted to Apache™ Spark®. The driver collects the results of the distributed execution, converts it to JavaScript Object Notation (JSON)/Extensible Markup Language (XML) and returns them back to the web server. The web server in turn streams it back to the user's web browser where it is displayed in rich format using Java Script.

Users can write their own nodes too and use them in their workflows. When a user writes his own Node, it is written in Java/Scala, extends the Node class and implements the execute method. If the Node changes the schema of the incoming DataFrame, then it also overrides the output Schema method. Output Schema method takes the input schema to this node and applies the changes to it for the next node. This way the user interface is able to display the various fields in the node dialog box which require the user to select the variables, intelligently.

DataFrame is a Spark® terminology and relates to a distributed DataSet. It refers to the distributed data that form the dataset and is distributed across the different machines of the cluster.

The user interface allows the user to create and edit the workflows. It also allows the user to execute the workflows.

The system provides various things to the user when editing a workflow. A workflow consists of nodes connected to each other in a DAG. Double clicking on any node of the workflow brings up the dialog box for the node. The dialog box allows the user to specify the fields for the node.

The output Schema interface of the nodes helps the user interface to intelligently display the various selections to the user. Some of the fields of a node require the user to select one or more of the incoming fields. So, when needed the user interface asks the workflow to give it the schema of any given node. The workflow traces the path from the beginning to the node to find the incoming schema for the node. The schema propagation is also the driving force behind the dependency free integration of the user interface (UI) to the backend engine of Spark®.

Below is the JSON of an example node. There are parameters like name, description, type etc. which define specific details about the node. Each node also has a list of fields in it. Each field has a widget type. Widget types can be text field, variable, variables, variables_map, variables_map_edit, enum etc. Each of these widget types allow the field to behave in a specific way when displayed to the user in the dialog box. For example, for the variable widget, the user is given a list of variables which are valid for that field, and select one from them. The variables widget is similar to variable, except that the user can select multiple variables from the list. The data types parameter specifies the kind of data types that field would handle. Hence, the user interface is able to only display those fields to the user. The title and description parameters are used to display the field title and description of the node and the fields to the user.

Each field also has an array of datatypes. This array makes the field further intelligent in terms of the kind of variables it supports.

```
  {
  “id”: “5”,
  “name”: “LogisticRegression”,
  “description”: “”,
  “type”: “ml”,
  “nodeClass”: “fire.nodes.ml.NodeLogisticRegression”,
  “fields” : [
  {“name”: “elasticNetParam”, “value”:“0.0”, “widget”: “textfield”, “title”:
“ElasticNet Param”, “description”: “The ElasticNet mixing parameter.
For alpha = 0, the penalty
is an L2 penalty. For alpha = 1, it is an L1 penalty”, “datatypes”:[“double”]},
  {“name”: “featuresCol”, “value”:“”, “widget”: “variable”, “title”: “Features
Column”, “description”: “Features column of type vectorUDT for model fitting”,
“datatypes”:[“vectorudt”]},
  {“name”: “fitIntercept”, “value”:“true”, “widget”: “array”, “title”: “Fit Intercept”,
“arrayValues”: [“true”,“false”], “description”: “Whether to fit an intercept term”,
“datatypes”:[“boolean”]},
  {“name”: “labelCol”, “value”:“”, “widget”: “variable”, “title”: “Label Column”,
“description”: “The label column for model fitting”, “datatypes”:[“double”]},
  {“name”: “maxIter”, “value”: “100”, “widget”: “textfield”, “title”: “Maximum
Iterations”, “description”: “Maximum number of iterations (>=)”, “datatypes”:
[“integer”]},
  {“name”: “probabilityCol”, “value”:“”, “widget”: “textfield”, “title”: “Probability
Column”, “description”: “The column name for predicted class conditional
probabilities”},
  {“name”: “predictionCol”, “value”:“”, “widget”: “textfield”, “title”: “Predictor
Columns”, “description”: “The prediction column created during model scoring”,
{“name”: “rawPredictionCol”, “value”:“”, “widget”: “textfield”, “title”: “Raw
Prediction Column”, “description”: “The raw prediction (a.k.a. confidence)
column name”},
  {“name”: “regParam”, “value”:“0.0”, “widget”: “textfield”, “title”:
“Regularization Param”, “description”: “The regularization parameter”,
“datatypes”:[“double”]},
  {“name”: “standardization”, “value”: “true”, “widget”: “array”, “title”:
“Standardization”,“arrayValues”: [“true”,“false”], “description”: “Whether
to standardize the
training features before fitting the model”, “datatypes”:[“boolean”]},
  {“name”: “threshold”, “value”: “0.5”, “widget”: “textfield”, “title”: “Threshold”,
“description”: “The threshold in binary classification prediction”, “datatypes”:
[“double”]},
  {“name”: “tol”, “value”:“1E-6”, “widget”: “textfield”, “title”: “Tolerance”,
“description”: “The convergence tolerance for iterative algorithms”, “datatypes”:
[“double”]},
  {“name”: “weightCol”, “value”:“”, “widget”: “textfield”, “title”: “Weight
Column”, “description”: “If the ‘weight column’ is not specified, all
instances are treated equally
with a weight 1.0”}]
}
```

There is also a nodeRules.json file. It defines the rules by which the nodes are connected to each other. It is used by the user interface to guide the user towards connecting the nodes in the right way. Below is a section of this rules file. For example, the first rule states that ‘dataset’ nodes cannot accept any inputs. The second rules states that the ‘transform’ node can take inputs from ‘dataset’, ‘transform’ and ‘join’ nodes. They have to have a minimum number of 1 input connection. They can have a maximum of 1 output connection.

```
{
“rules”:[
  {
    “nodeType”: “dataset”,
    “possibleSources”:[ ],
    “minNumOfConn”: 0,
    “maxNumOfConn”: 0,
    “connRestrictions”:[ ]
  },
  {
    “nodeType”: “transform”,
    “possibleSources”: [“dataset”,“transform”,“join”],
    “minNumOfConn”: 1,
    “maxNumOfConn”: 1,
    “connRestrictions”:[ ]
  },
  {
    “nodeType”: “ml”,
    “possibleSources”: [“dataset”,“transform”,“join”],
    “minNumOfConn”: 1,
    “maxNumOfConn”: 1,
    “connRestrictions”:[ ]
  },
```

The system also provides a way for the users to define the datasets. Many other systems provide this and they form the basis of the computations that can be performed on them.

The system allows the user to define datasets on files in HDFS (Hadoop® Distributed File System), HIVE tables, HBase tables and Solr collections. This can easily be extended in the future for new data sources. When defining the datasets the user is provides an intelligent easy way to define the column name and data type of each of the columns of the dataset, essentially defining the schema of the dataset quickly.

The nodes of the system are also able to interact with other systems like HBase, Solr, Relational Databases, Kafka, Flume, etc. The Schema propagation feature of the system enables mapping the variables for these external systems.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, compact disk-read only memory (CD-ROMs), flash drives, random access memory (RAM) chips, hard drives, erasable programmable read-only memory (EPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

Appendix A attached hereto is U.S. Pat. No. 9,031,925 B2 and is being submitted as a source of terminology as used in the present provisional patent application.

Appendix B attached hereto is an English language translation of Chinese Patent Publication No. CN 104360903 A and is being submitted as a source of terminology as used in the present provisional patent application.

Appendix C attached hereto is a PowerPoint presentation concerning embodiments of the present invention.

What is claimed is:

1. In a system including a web server, data storage and a Spark® cluster, a computer-implemented method comprising the steps of:
(a) at the web server, receiving from a user computer browser application a request for execution of a workflow;
(b) at the web server, submitting the request for execution of the workflow to the Spark® cluster as a Spark® job including information about the workflow details, the request being submitted to a driver running on the Spark® cluster, wherein the driver creates an in-memory representation of the requested workflow from the submitted information about workflow details, wherein the driver creates an execution plan of the requested workflow for the Spark® cluster, and wherein the driver starts execution of a plurality of nodes of the requested workflow on at least one executor on the Spark® cluster;
(c) at the web server, receiving the result of the execution of the workflow from the driver running on the Spark® cluster after each node of the workflow request has been executed on the Spark® cluster; and,
(d) at the web server, creating JSON/XML-format files containing the received results of the execution of the workflow, such that when the JSON/XML format files are processed by the user computer web browser, the results are displayed on the user computer as rich text/table/chart/tree visual displays.

2. In a system including a web server, data storage and a Spark® cluster, a computer-implemented method comprising the steps of:
(a) at a user computer browser application, receiving from the web server a list of nodes; node specifications; and a plurality of rules by which to connect various types of nodes;
(b) at the user computer browser application, receiving user inputs for creating/editing a workflow, and for editing fields of the listed nodes; of the workflow.
(c) at the user computer browser application, submitting a request to the web server for a schema for a listed node;
(d) at the user computer browser application, receiving a response for the requested schema; and
(e) at the user computer browser application, using the schema received from the web server, displaying on the user computer display fields of a dialog in an appropriate manner.
